(19) United States
(12) Patent Application Publication
(10) Pub. No.: US 2021/0317684 A1
(43) Pub. Date: Oct. 14, 2021

(54) CHANGING A STATE OF A LOCK

(71) Applicant: Essence Smartcare Ltd., Herzlia Pituach (IL)

(72) Inventors: Yaron OPPENHEIM, Herzliya (IL); Barak KATZ, Petach Tikva (IL); Ohad AMIR, Herzlia (IL)

(21) Appl. No.: 17/269,011

(22) PCT Filed: Aug. 15, 2019
(86) PCT No.: PCT/IL2019/050918

§ 371 Date: Feb. 17, 2021

(30) Foreign Application Priority Data
Aug. 17, 2018 (LU) LU100905

(51) Int. Cl. E05B 47/00; E05B 63/00

(52) U.S. Cl. CPC E05B 47/0012; E05B 63/0069; E05B 2047/0091; E05B 2047/0083; E05B 2047/0094; E05B 2047/0069

(57) ABSTRACT

Described herein is a lock actuation assembly for actuating a state change of a lock of a door via a lock actuator extending from a panel of the door, comprising: a motor for driving the actuation; a body having a mounting portion for attaching the lock actuation assembly to the door; a coupler held by the body for coupling a force from the motor to the lock actuator to change the lock's state; a wireless communication module for receiving in, an electromagnetic signal, a first command for changing the state of the lock; a turnable piece on the body for generating a second command for changing the state of the lock; and a controller adapted to control the motor to change the state of the lock based on either one of the first command or the second command.

### RELATED APPLICATION

This application claims the benefit of priority from Luxembourg Patent Application No. LU100905 filed on 17 Aug. 2018, the contents of which are incorporated herein by reference in their entirety.

### TECHNICAL FIELD

The present invention relates to a lock actuation assembly for actuating a change of a state of lock of a door via a lock actuator that extends from a panel of the door.

### BACKGROUND

There is a growing need for electronically actuated locks. However, the installation of such locks has potential to be difficult and/or costly. Many electronically actuated locks are installed by replacing an existing mechanical lock, or are integrated into a door with no prior lock. In some instances, it may be preferred to maintain the installation of the existing mechanical lock and to retrofit a lock actuation assembly without having to remove any of the existing lock. Maintaining the existing lock may advantageously make installation and/or or removal of the lock actuation assembly simpler than replacing some or all of the existing lock.

Such a retrofitted lock actuation assembly may include an electronically actuated motor which drives actuation of the existing mechanical lock via a lock actuator, e.g. a key or thumb-turn, in the existing lock.

Some lock actuation assemblies may enable the lock to be actuated by a wirelessly received command, e.g. from a phone or smart watch, or by a physical interaction with the lock actuation assembly. However, the manner of the physical interaction may be unnatural or difficult to some users, especially elderly users.

The present invention aims to solve or ameliorate at least one of the above or other problems of the prior art and/or provide a market alternative.

Reference to any prior art in this specification is not an acknowledgement or suggestion that this prior art forms part of the common general knowledge in any jurisdiction, or globally, or that this prior art could reasonably be expected to be understood, regarded as relevant/or combined with other pieces of prior art by a person skilled in the art.

### SUMMARY OF THE INVENTION

The present invention provides, in one aspect, a lock actuation assembly for actuating a change of a state of lock of a door via a lock actuator that extends from a panel of the door, the lock actuation assembly comprising:
a motor for driving the actuation of the change of the state of the lock by a mechanical force;
a body having at least one mounting portion for attaching the lock actuation assembly to the door;
a coupler held by the body for coupling the mechanical force to the lock actuator to change the state of the lock by turning the lock actuator relative to the body;
a wireless communication module for receiving in, an electromagnetic signal, a first command for changing the state of the lock;
a turnable piece on the body for generating a second command for changing the state of the lock; and
a controller adapted to control the motor to generate the mechanical force to change the state of the lock based on either one of the first command or the second command.

Thus, advantageously, a user may actuate the lock by providing the electromagnetic signal, e.g. from a smart phone of smart watch, but out of preference or necessity may alternatively actuate the lock by turning the turnable piece. The ability to actuate the lock by turning a piece on the body may advantageously feel more natural and intuitive than other actions, especially for elderly users, who might be intimidated and/or confused by actuation actions that they are not used to.

In some embodiments the turnable piece on the body is a rotatable thumb-turn. Thus, the turnable piece may present to a user an actuation means that is particularly familiar to the user and intuitive for them to use.

Further, using the turnable piece to generate an electronic command that in turn is used to control the motor enables local actuation at the lock actuation assembly that does not require the user to mechanically force movement of the actuator. For example, in an event the user does not have access to a relevant device to wirelessly command the electronic lock, they may need to physically turn the lock against the mechanical resistance presented by the motor, and nor do they need to perform an operation to firstly remove that mechanical resistance. Thus, by the present invention providing a turnable piece for changing state based on an electronic command, there may be comparatively less physical energy and/or effort needed from the user to locally actuate the lock.

The second command may be a change in an electronic state corresponding to a change in a state of a switch. In some embodiments, the switch comprises the turnable piece. The switch may in some embodiments also comprise processing circuitry, which may be provided for example by the controller. For example, the turn-able piece may have a first position that defines a first switch state and a second position that defines a second switch state. In some embodiments, an angular separation between the first position and second position is predefined. For example, the first position and second positions may each be predefined relative to the body. The switch states may also be changed in response to motion of the turnable piece towards the first or second position. In some embodiments the first switch state and the second switch state correspond to respective predefined states of the lock. For example, the first switch state may always correspond to a locked state of the lock, and the second switch state may always correspond to a locked state of the lock.

In some embodiments, the coupler may have an opening to engage the lock actuator.

In another aspect of the present invention, there is provided a lock actuation assembly for actuating a change of a state of lock of a door via a lock actuator that extends from a panel of the door, the lock actuation assembly comprising:
a motor for driving the actuation of the change of the state of the lock by a mechanical force;
a body having a mounting portion for attaching the lock actuation assembly to the door;
a coupler held by the body for coupling the mechanical force to the lock actuator to change the state of the lock by turning the lock actuator relative to the body; and
a controller adapted to control the motor to generate the mechanical force to change the state of the lock based on a received command,
wherein the controller determines and stores the state of the lock based on a comparison of: (i) a measured electrical characteristic associated with an actuation of the lock from a locked to an unlocked state; and (ii) a measured electrical characteristic associated with an actuation of the lock from an unlocked to a locked state.

In addition to any embodiments described above, embodiments of each of these aspects of the invention will be apparent form the appended claims, figures and detailed description which follows. Further, embodiments of each one of the aspects of the invention are applicable to the other of the aspects of the invention.

As used herein, except where the context requires otherwise, the terms “comprises”, “includes”, “has”, and grammatical variants of these terms, are not intended to be exhaustive. They are intended to allow for the possibility of further additives, components, integers or steps.

Various embodiments of the invention are set out in the claims at the end of this specification. Further aspects of the present invention and further embodiments of the aspects described in the preceding paragraphs will become apparent from the following figures and description, given by way of non-limiting example only. As will be appreciated, other embodiments are also possible and are within the scope of the claims.

### BRIEF DESCRIPTION OF THE SEVERAL VIEWS OF THE DRAWINGS

FIG. 1 is a drawing representing side view of an exemplary lock actuation assembly, in accordance with one or more aspects of the present invention, fitted to a door having a lock assembly installed therein, the lock assembly including a lock and an escutcheon, the door being viewed from above the door;

FIG. 2A a top view of the lock actuation assembly of FIG. 1, showing a turnable piece in a first position;

FIG. 2B is a top view of the lock actuation assembly of FIG. 1, showing the turnable piece in a second position

FIG. 3 is a bottom view of the lock actuation assembly of FIG. 1;

FIGS. 4A to 4C show a top view of a lock actuation assembly for use with a left-hinged door; and

FIGS. 5A to 5C show a top view of a lock actuation assembly for use with a right-hinged door.

### DETAILED DESCRIPTION OF THE EMBODIMENTS

In general terms, not intended to define the scope of the invention, a lock actuation assembly according to the present invention has a coupler which couples a rotational force, generated by a motor, to an actuator in a door-mounted lock, and there are at least the following two ways in which the motor may be triggered to generate the force. One of the ways of triggering the motor is by the lock actuation assembly wirelessly receiving a command. This may involve the controller receiving a command from a wireless communication module. The other of the ways of triggering the motor is by turning (e.g. rotating) a turnable piece with respect to a body of the lock actuation assembly. The coupler may for example be a slotted driver, or in any other way comprise a receptacle for holding part of the actuator. Turning the turnable piece causes rotation of the coupler, but this causation is by an electronic coupling, rather than a mechanical coupling, between the turnable piece and the coupler. Thus, a user can actuate the lock by an intuitive action (turning of a piece of the assembly), yet the action causes electrically powered rotation of the actuator.

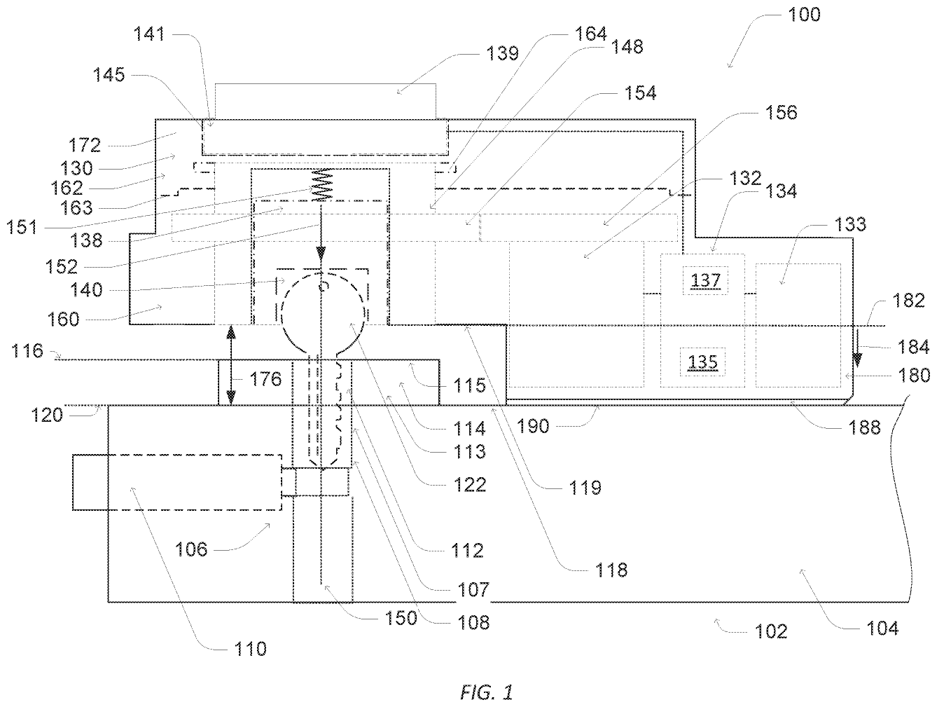

An exemplary embodiment of the present invention is depicted in FIG. 1, showing the lock actuation assembly 100, in a side view, retrofitted to a door 102 of a building.

FIG. 1 shows a top view of the door 102, but not showing a handle of the door. The door 102 has a panel 104, which may for example be mounted to a vertical wall (not shown) by vertical hinges (not shown). A lock assembly 106 is integrated into the door 102. The lock assembly 106 has lock 107 comprising a cylinder 108, which in this example a double cylinder, but in other examples may be a single cylinder. Rotation of a lock actuator 122, which is a key in this illustrated example but is a thumb-turn in other examples, actuates the lock-mechanism (e.g. a pin tumbler mechanism or any other lock-mechanism) in the cylinder 108 to selectively move of a bolt 110 of the lock 107 into an extended position to hold the door closed, or a retracted position to allow the door to freely move between open and closed positions.

With the lock assembly 106 installed, the door has a raised portion 113 that comprises an end 112 of the cylinder 108 and an escutcheon 114 that surrounds the protruding end 112 of the cylinder 108 and creates a flush surface 115 with cylinder 108 in a first plane 116. The first plane 116 is parallel to a second plane 120 in which lies a surface 118 of the panel 104 that faces the lock actuation assembly 100. In the illustrated embodiments, the cylinder 108 has a key hole that receives a key. However, in other embodiments there is a thumb-turn in place of the key and key hole, the thumb-turn extending from the cylinder 108 beyond the surface 115, instead of the key.

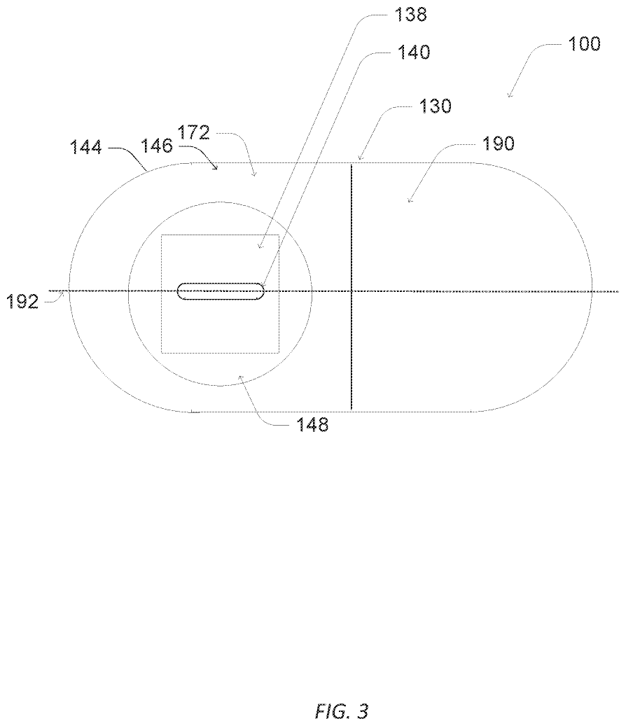

The lock actuation assembly 100 has a body 130 holding a motor 132 for driving mechanical actuation of the lock 107 by a rotational force. The head of the lock actuator 122 is received within a driver/coupler 138 for coupling a rotational force, generated by the motor 132, to the lock-actuator 122 to turn the lock-actuator 122 when the motor is commanded to generate the force. Referring to FIG. 3, which shows a bottom view of the lock actuation assembly 100, the coupler 138 may have an opening 140 comprising an opening for mating reception a head of a key or a thumb-turn, and may be shaped to fit (i) a particular type of key; (ii) a particular type of thumb-turn; or (iii) either the key or the thumb-turn. In the illustrated example the opening comprises a slot for the receiving a part of the lock actuator 122. For example, the slot may receive a thumb-turn actuator and/or a head of a key (as shown in the illustration). In another example in which the actuator is again a key, the coupler is comprises a key holder that has the slot, wherein slot opens into a cavity that is further from the door than the slot, wherein a head of a key is positioned in the cavity and a shaft of the key extends through, and from, the slot to enter a key hole in the lock.

Returning to FIG. 1, the coupler 138 is held by a receptacle 148 in which the coupler 138 may slide along an axis 150 about which the coupler 138 rotates to turn the thumb-turn/key 122 when actuating the lock 107. A spring 151 may be incorporated to bias the coupler in a direction 152 towards the door 102 and in line with the axis 150.

A first gear 154 is mounted on the receptacle 148 and is coaxial with the axis 150. A second gear 156 is attached to, and centered on, an output shaft of the motor 132, which in some embodiments is a stepper motor and in other embodiments is a brushed DC motor. The first gear 154 and the second gear 156 mesh so that the rotational force, when provided by the motor, is transferred to coupler 138.

The body also has a mounting portion 180 extending down from the main part 172 of the body, the main part 172 being the portion of the body 130 that is above a plane 182 in which lies the raised underside 119 of the body 130. The extension is in a direction 184 that is parallel to axis 150 and therefore parallel to the direction 152 of the bias of the coupler 138. The underside of the mounting section 180 includes an adhesive layer 188, which may be comprised of a single sheet or a plurality of strips, for example, and in some embodiments expands across most, and in some embodiments all, of the underside of the mounting portion 180. The underside 190 of the adhesive layer 188 acts contact surface against the door panel 104 in the second plane 120.

Having the underside 119 recessed/raised with respect to the door panel contact surface 190 (i.e. set back from this surface) enables the coupler 139 to be disposed above the raised portion 113 of the door 102, with the mounting portion 180 being in mounting contact with the door panel 104. In some embodiments (not shown), the body 130 includes another mounting portion (not shown) on an opposite side of the coupler 148 to said mounting portion 180.

The motor 132 is powered by one or more batteries 133 in the body 130, and electronics 134 in the body 130 control the motor 132 based on an electronically derived command.

The electronics 134 comprises a controller 135 which may include one or more processing devices, e.g. a microcontroller, microprocessor, field programmable gate array (FPGA), application-specific integrated circuit (ASIC) chip.

The electronics 134 also includes a memory, which may be integrated in the processing device(s) or may be separate. Further the memory may comprise a plurality of memory types and/or devices as would be known by a person skilled in the art. For example, non-transient memory may store code for configuring the functions and methods performed by processor(s) and transient memory may be used by the processor(s) to write and read temporary data used by the processor(s) during their operation. The memory may also store calibration or configuration information that is determined during installation and setup of the lock.

The controller 135 may also include discrete components, e.g. for electrically driving the motor and for performing logic operations on command inputs. Such logic operations may, of course, alternatively be performed in any onboard processing chip. As will be clear from the description herein, one such logic operation may for example be an “OR” operation on a first command from a wireless communication module 137 and a second command from rotation of a turnable piece 139, which acts as a thumb-turn switch.

The communication module 137 may be entirely or partly included in a processing device that also includes the controller 135. The communication may support any one or more of a plurality of wireless communication protocols, for example Wi-Fi, Bluetooth, 4G communication, which may be transmitted from a smart phone, for example. Additionally or alternatively one or more of these or other wireless communication protocols may be utilized by a stationary computing device to transmit the first command to the lock actuation assembly from, or via, such a stationary device.

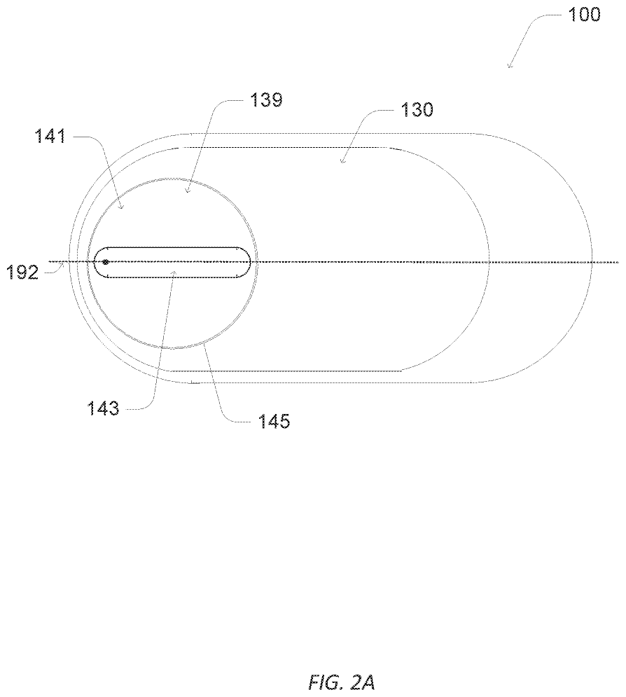

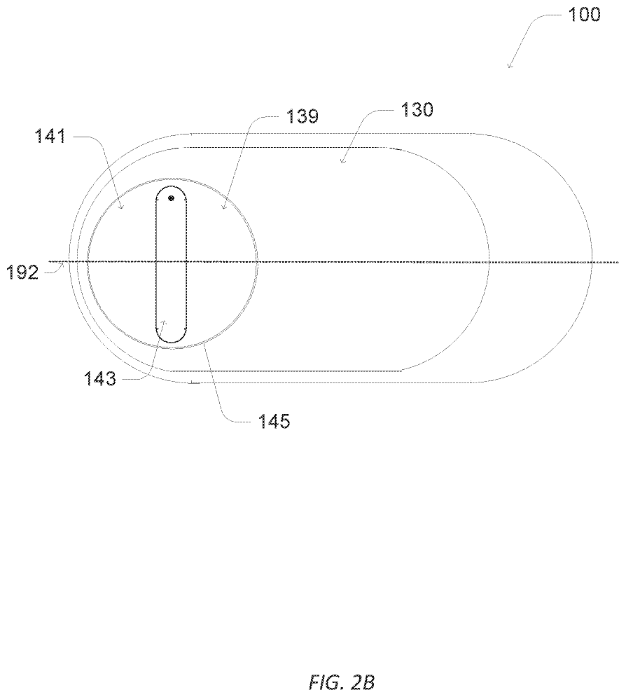

In the illustrated example, the turnable piece 139 has a cylindrical base 141 that is held in a cradle 145 of the turnable piece 139, the cradle proving a complementarily shaped cylindrical cavity. The piece 139 has linear handle 143 (FIG. 2A) extending from the cylindrical base 141 for turning the base 141 relative to the cradle 145. The cradle 145 may be integrated with, or formed in, the base 141 prior to fitting in the body 130, or may be firstly integrated with the body 130 and then receive the base 141. In any case, the cradle has a fixed orientation with respect to the body 130 such that the base 141 is rotatable with respect to the cradle 145 to change a configuration of the piece 139 between a first position in which a switch has a first state and a second position in which a switch has a second state. The switch may be provided, for example, by including one or more contacts on the base 141 and one or more contacts in the cradle 145 in any number of manners, as will be understood by a person skilled in the art.

The first state and second state are mutually exclusive states whereby, for example, the first state may define a closed switch state and the second state may define an open switch state. FIG. 2A illustrates the first of the switch positions, in which the longitudinal axis of the handle is aligned with the longitudinal axis 192 of the body 130. The second state of the switch positions is illustrated in FIG. 2B, which shows the longitudinal axis of the handle is perpendicular with the longitudinal axis 192 of the body 130. In other embodiments, the second switch position may be separated from the first position by 180 degrees.

While the embodiments described above define a 2-pole switch, it will be appreciated that switches having another number of poles may be used. For example, the switch may be a 4-pole switch, with each pole being separate by 90 degrees, and alternating poles corresponding to the same switch state. For example, a closed switch state may exist for each of two 180-degree separated configurations in which the longitudinal axis of the handle is aligned with the longitudinal axis 192 of the body 130; and an open switch state may exist for each of two 180-degree separated configurations in which the longitudinal axis of the handle is perpendicular with the longitudinal axis 192 of the body 130.

In some embodiments, movement of the switch into a given position results in a command that the lock be in a specific state, i.e. a predefined one of either a locked state or an unlocked state, that is always the same for that position. However, in such or some other embodiments, the determination of whether the movement of the piece 139 commands a lock or an unlock action, depends on the direction of movement of the switch, rather than the steady state position of the switch. In other words, a given detected direction of rotation may define whether the output of the change of the switch state commands a locking or an unlocking of the lock. For example, a clockwise rotation may define a command to unlock the lock and a counter-clockwise rotation may define a command to lock the lock, or vice-versa. In yet other embodiments, a change of position of the switch may correspond to a command to change the state of the lock from whatever its current state is to whatever its opposite state is. For example, if the lock is unlocked, then changing the position of the switch, in any direction, results in a command to lock the lock, whereas if the lock had been in the locked state, that same change of position of the switch would have resulted in a command to unlock the lock.

Optionally, the turnable piece 139 presents a thumb-turn to a user, which may be configured to mimic operation of the actuator 122. For example, if a clockwise half-turn of the actuator is required to unlock the lock, corresponding first and second positions of turnable piece 139 may be set during installation to define that an unlocking command is provided by a clockwise half-turn rotation of the turnable piece 139, thereby closely mimicking the actuator action. Alternatively, the direction and/or angular separation between locked and unlocked positions of the turnable piece 139 may differ from that of the actuator 122. Further, the turnable piece 139 may be continuously rotatable in some embodiments, or by contrast, may have a limited angular range of rotation in other embodiments.

During use, the commands derived from the turnable piece 139 and wireless communication module 137 are combined with logic in the controller 135, so that a commanded change of state from or based on either the turnable piece 139 or communication module 137 results in the controller controlling the motor to change the state of the lock 107 by turning the actuator 122. Thus, in the absence of a smart phone to generate a command for the lock 107, the user can still actuate the lock in an intuitive manner that nonetheless utilizes the motor 132.

The lock actuation assembly may also provide a provision to manually rotate the coupler 148, so that a user can actuate the lock in an event of an electrical failure of the lock actuation assembly, e.g. due to batteries 133 reaching their end of life. For example, the lock actuation assembly may further include mechanical access to the coupler, from a side of the lock actuation assembly that faces away from the door, for physical manipulation of the coupler. The user may access and directly manipulate the coupler 148 by removing a cover 162 of the body 130 that may slide and/or clip into attachment to a base 160 of the body 130 to thereby expose a gripping portion 164 on the coupler 148 to rotate the coupler. The gripping portion is in some embodiments a ring around the coupler 148, with indentations around its outer circumference to assist in gripping. In the illustrated embodiment the turnable piece 139 is held by the cover 162 and is thereby removed by removing the cover 162. However, in other embodiments (not shown) the turnable piece 139 is offset from the coupler 148 and is held by the base 160. For such embodiments, the turnable piece 139 need not be removed in order to access the gripping portion 162.

When the door lock actuation assembly is mounted to a door, the direction in which a person most intuitively turns for a locking or unlocking action depends on whether the lock is mounted to a left-hinged door, or to a right-hinged door. This is taken from the perspective of the side of the door to which the lock actuation assembly is mounted.

In order to address this, lock states resulting from operation of the turnable piece and actuating the switch states may be configurable. Providing configurable lock states enables the locking and unlocking actions to be configured for defined movements of the turnable piece. The lock states may be manually programmed, for example via a wireless interface. In some embodiments, the orientation of at lock actuation assembly may determine whether clockwise or counter-clockwise action of the turnable piece actions the lock assembly to lock or unlock.

The orientation could be, for example, the orientation of at least a part of the body of the lock actuation assembly 100.

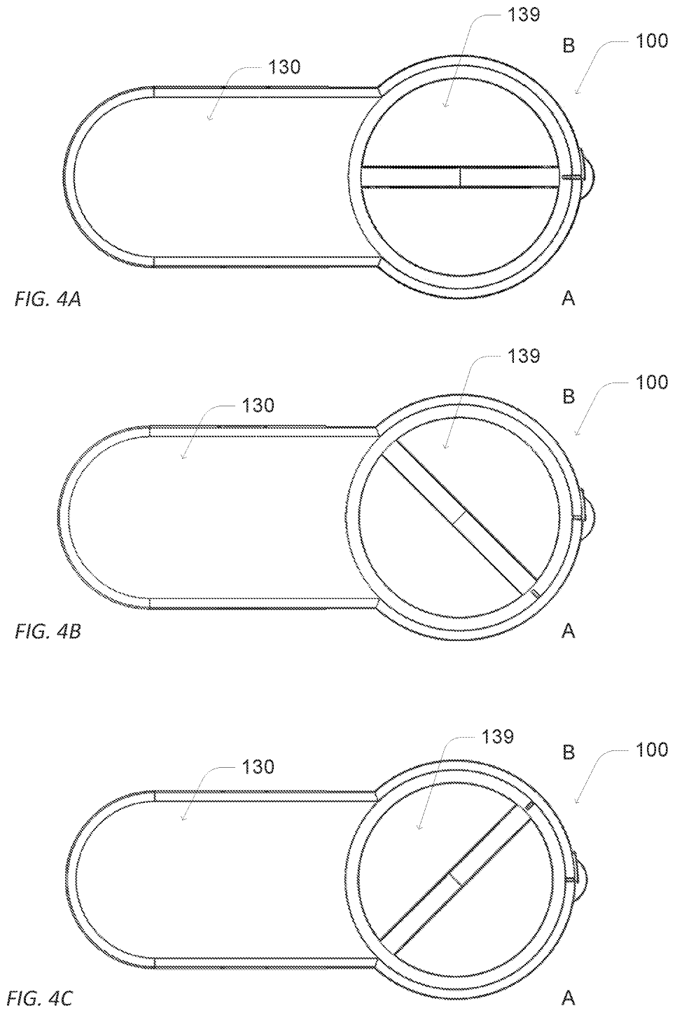

FIGS. 4A to 4C show an example operation of a lock actuation assembly 100 when mounted for operation of a left-hinged door, taken from the perspective of the side of the door to which the lock actuation assembly 100 is mounted, so the edge of the door is to the right of the lock actuation assembly 100. In FIG. 4A, the turnable piece 139 is biased to a neutral position as shown. Rotating the turnable piece 139 clockwise towards position A, as shown in FIG. 4B, may cause the lock actuation assembly 100 clockwise to lock. Rotating the turnable piece 139 counter-clockwise towards position B, as shown in FIG. 4C, may cause the lock actuation assembly 100 to turn counterclockwise to unlock.

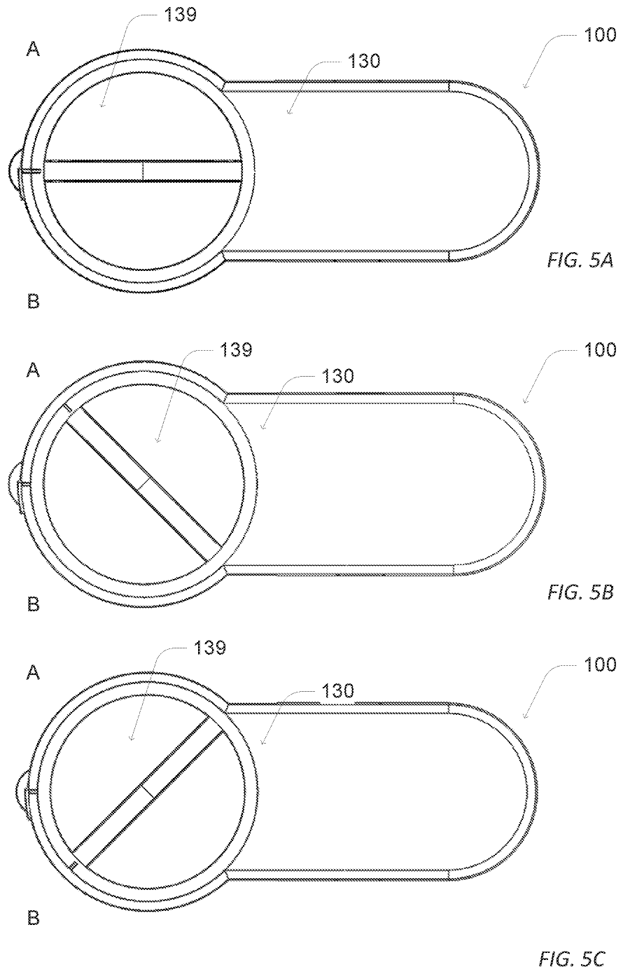

FIGS. 5A to 5C show an example operation of a lock actuation assembly 100 when mounted for operation of a right-hinged door, taken from the perspective of the side of the door to which the lock actuation assembly 100 is mounted, so the door edge is to the left of the lock actuation assembly 100. In FIG. 5A, the turnable piece 139 is biased to a neutral position as shown. Rotating the turnable piece 139 clockwise towards position A, as shown in FIG. 5B may cause the lock actuation assembly 100 to turn clockwise to unlock. Rotating the turnable piece 139 counter-clockwise towards position B, as shown in FIG. 5C, may cause the lock actuation assembly 100 to turn counterclockwise lock.

Since the lock states are configurable with respect to the movement of the turnable piece, the lock actuation assemblies 100 of the above examples may instead, in other embodiments, be configured to lock and unlock in the opposite direction to those described in the above examples, in an unusual case in which it be required by the lock in the door.

In any case, the turnable piece 139 may be biased to the neutral position so that when a person releases the turnable piece 139, it is returned to the neutral position. This may be achieved by means of springs or other means known in the art. For example, springs may be held in a channel beneath the turnable piece 139, and the springs interact with an engagement means, for example a rod, protruding from underneath the turnable piece 139 into the channel. First and second springs may be placed either side of the engagement means such that when the turnable piece 139 is rotated away from the neutral position, the engagement means interacts with the first spring to put the first spring in tension and with the second spring to put the second spring in compression. Releasing the turnable piece 139 causes the first and second springs to return to their initial positions, thus returning the turnable piece 139 to the neutral position.

As discussed above, the lock states may be configurable by programming for example a wireless interface. When the lock states are configurable dependent on the orientation of at least a part of lock actuation assembly 100, the orientation of the device may be sensed for example by means of an orientation sensor, which may for example comprise an accelerometer, incorporated into the assembly. The orientation may, for example, be sensed based on at least a part of the body 130 of the lock actuation assembly 100. An orientation sensor may integrated into the body 130. However in other embodiments, in which the turnable piece has a limited range of angular rotatability, such that it may be implied from the orientation of the turnable piece whether the body is mounted on towards the left or right edge of a door, the orientation sensor may be integrated into the turnable piece 129. Once the orientation of the lock actuation assembly is known, the respective switch positions that correspond to the lock and unlock positions may be stored in memory on the lock actuation assembly, for later use by the controller 135.

Alternatively, the orientation of the device, in terms of it being oriented for mounting on towards a left or right edge of door, may be programmed manually by the user prior to using the lock actuation assembly 100.

However, for most door locks, the intuitive direction to turn the turnpiece 139 is the same as the direction that the coupler 138 needs to turn to actuate the lock, as is described in relation to FIGS. 4 and 5. Therefore the controller 135 may be configured to always turn the coupler 138 in the same direction in which the turnpiece 139 is turned. The controller may determine and store the state of the lock based on a comparison of: (i) a measured electrical characteristic associated with an actuation of the lock from a locked to an unlocked state; and (ii) a measured electrical characteristic associated with an actuation of the lock from an unlocked to a locked state. Configuration of the controller in this manner may be especially beneficial in cases where the lock actuation is installed in an orientation that is the same for both right hinged and left hinged doors. For example in the case of the exemplary lock actuation assembly 100, this applies to installations in which the longitudinal axis 192 of the lock actuation assembly 100 is vertical.

For each measurement used in the comparison the controller knows the direction (clockwise or counterclockwise) with which the lock was actuated to obtain the measurement. Since, in standard locks, standard lock actuation is counterclockwise to unlock locks at the right edge of a door and clockwise to unlock locks at the left edge of a door, the controller can determine whether the lock actuation lock is positioned at a right edge of a door or a left edge of the door, based on the determined state of the lock for the known turning direction for which its associated measurement of the electrical characteristic was made. For example, if it was determined by the controller, based on the comparison of the measured electrical characteristics during locking compared with unlocking, that a counter-clockwise turn of the actuator corresponds to unlocking the lock, then it can be implied that the lock is installed at the right edge of a door, and the controller can configure itself to define position B of the turnable piece 139 (i.e. the position counterclockwise from the other position A) as corresponding to unlocking the door.

The measured electrical characteristic associated with an actuation of the lock from a locked to an unlocked state, and the measured electrical characteristic associated with an actuation of the lock from an unlocked to a locked state, is in some embodiments based on a power indicative parameter, e.g. current for a constant voltage, which may be measured during the respective actuations.

The measured electrical characteristic associated with an actuation of the lock from a locked to an unlocked state may be during a time period that spans at least a part of an unlocking actuation, and the measured electrical characteristic associated with an actuation of the lock from an unlocked to a locked state during a predefined time window associated with a time period that spans at least a part of an locking actuation. The part of the locking actuation and the part of the unlocking actuation may commence a common amount of time after the commencement of the respective actuations, and/or after an elapsing of a common percentage of the durations of the respective actuations. Additionally or alternatively, the part of the locking actuation and the part of the unlocking actuation may occur after respective initial phase of the locking and unlocking actuations.

The measured electrical characteristic associated with an actuation of the lock from a locked to an unlocked state, and the measured electrical characteristic associated with an actuation of the lock from an unlocked to a locked state is in some embodiments based on an RMS measurement. In some embodiments RMS measurements for the respective locking and unlocking actuations may be measured over the whole of the respective actuations, or in other embodiments they may be measured after respective initial phases of the actuations. The measured electrical characteristic associated with an actuation of the lock from a locked to an unlocked state, and the measured electrical characteristic associated with an actuation of the lock from an unlocked to a locked state is in some embodiments additionally or alternatively based on a peak measurement. In some embodiments peak measurements for the respective locking and unlocking actuations may be measured over the whole of the respective actuations, or in other embodiments they may be measured after respective initial phases of the actuations. The measured electrical characteristic associated with an actuation of the lock from a locked to an unlocked state, and the measured electrical characteristic associated with an actuation of the lock from an unlocked to a locked state is in some embodiments additionally or alternatively based on a duration of transient parameter, e.g. a duration of a transient power change that corresponds to the associated actuation.

The measured electrical characteristic associated with an actuation of the lock from a locked to an unlocked state, and the measured electrical characteristic associated with an actuation of the lock from an unlocked to a locked state is in some embodiments additionally or alternatively based on measured energy consumption during.

In some embodiments, the controller only makes the determination in an event that the comparison of: (i) a measured electrical characteristic associated with an actuation of the lock from an unlocked to a locked state; and (ii) a measured electrical characteristic associated with an actuation of the lock from a locked to an unlocked state defines a metric that is greater than predetermined threshold. For example, the metric may be a ratio of: (i) a measured electrical characteristic associated with an actuation of the lock from an unlocked to a locked state to (ii) a measured electrical characteristic associated with an actuation of the lock from a locked to an unlocked. In another example, the metric may be a difference between: (i) a measured electrical characteristic associated with an actuation of the lock from an unlocked to a locked state and (ii) a measured electrical characteristic associated with an actuation of the lock from a locked to an unlocked state. Four example the measured electrical characteristic may be indicative of power or total energy consumption during the entirety, of a common proportion of time of, the corresponding actuations, wherein the difference is that measured electrical characteristic associated with locking the lock minus that measured electrical characteristic associated with unlocking the lock.

Optionally, in some embodiments, an installer may verify, via an interface to the lock actuation assembly 100, that the determined lock state is correct. Thus, should the metric not be greater than the threshold then the controller may return a state unknown result.

Each of the above methods of determining a state based on a comparison of the measurements during locking and unlocking, may be used to exploit that for a majority of locks more RMS power and therefore more energy is required to push the bolt 110, than to pull, the bolt 110, after initial phases of the respective pushing and pulling. Typically for the pulling actuation, the power profile over time increases to an early peak during an initial phase and then decreases over time. By contrast for the pushing actuation, the power profile over time is relatively low during the initial phase but then increases. The profiles are such that there is more power consumed over the course of the pushing action than over the pulling action, and there is more power consumed over the course of the pushing action than over the pulling action, and this is most pronounced after the initial phase of the respective pushing and pulling actuations. It also means that there is the peak power late in the respective actuations is greater for the pushing actuation than for the pulling actuation. The differences in load may also result in the respective actuations having predictably different durations. As will be appreciated the “initial phase” referred to herein may be defined in many ways including for example, a predefined amount of time, an amount of time taken to reach peak power in a pulling actuation, or a percentage of the total time to perform an actuation, etc.

As will be appreciated by the person skilled in the art the mathematical calculations may be manipulated to work with reciprocals or negatives wherein rather than a testing whether a number is greater than the threshold, it may be tested whether its reciprocal or negative is less than a threshold. However, such and other mathematical equivalences are considered herein to be considered the same.

Furthermore, electronic components of any type, e.g. one or more switches or sensors, may be used to determine when the turnable piece 139 is in position A and when the turnable piece 139 is in position B. The lock actuation assembly 100 may be configured to change the switch state, and thus the lock state, when the turnable piece 139 is in position A or position B. However, the lock actuation assembly 100 may alternatively be configured to sense a direction of turning of the turnable piece 139 towards positions A or B and change the switch state, and thus the lock state, in response to the detection of motion in the direction towards positions A or B. Furthermore, the lock actuation assembly 100 may be configured to change a switch state, and thus a lock state, in response to detection of motion of the turnable piece 139 towards position A or B, and when it reaches position A or B.

The meaning of “first” and “second”, as used herein, is not intended to imply a temporal ordering. For example, reference to a “first state” and a “second state” does not imply the first state precedes the second state.

Where a given item is referenced herein with the preposition “a” or “an”, it is not intended to exclude the possibility of additional instances of such an item, unless context requires otherwise.

Where the specification defines a range, the stated outer extremities of the range are part of the range, unless context requires exclusion of the outer extremities from the range. From example, a range defined in terms of being between X and Y or from X to Y, should be interpreted as including X and Y.

The invention disclosed and defined herein extends to all plausible combinations of two or more of the individual features mentioned or evident from the text or drawings. All of these different combinations constitute various alternative aspects of the invention.

1. A lock actuation assembly for actuating a change of a state of lock of a door via a lock actuator that extends from a panel of the door, the lock actuation assembly comprising:
a motor for driving the actuation of the change of the state of the lock by a mechanical force;
a body having a mounting portion for attaching the lock actuation assembly to the door;
a coupler held by the body for coupling the mechanical force to the lock actuator to change the state of the lock by turning the lock actuator relative to the body;
a wireless communication module for receiving in, an electromagnetic signal, a first command for changing the state of the lock;
a turnable piece on the body for generating a second command for changing the state of the lock; and
a controller adapted to control the motor to generate the mechanical force to change the state of the lock based on either one of the first command or the second command.

2. A lock actuation assembly according to claim 1, wherein the turn-able piece on the body is a rotatable thumb-turn.

3. A lock actuation assembly according to claim 1, wherein the second command is a change in an electronic state corresponding to a change in a state of a switch.

4. A lock actuation assembly according to claim 3 wherein the switch comprises the turnable piece.

5. A lock actuation assembly according to claim 3 wherein the turnable piece has a first position that defines a first switch state and a second position that defines a second switch state, and an angular separation between the first position and second position is predefined.

6. A lock actuation assembly according to claim 5, wherein movement of the turnable piece towards the first position defines the first switch state and movement of the turnable piece towards the second position defines the second switch state.

7. A lock actuation assembly according to claim 5 wherein the first position and second positions are each be predefined relative to the body.

8. A lock actuation assembly according to any one of claims 3, wherein the turnable piece has a first position, a second position and a neutral position, the first and second positions having an angular separation between them and the neutral position being located between the first and second positions.

9. A lock actuation assembly according to claim 8, wherein the turnable piece is biased towards the neutral position.

10. A lock actuation assembly according to claim 5 wherein the first switch state and the second switch state correspond to respective predefined states of the lock.

11. A lock actuation assembly according to claim 5, wherein the first position and second position have configurable lock states, the first position being configurable to define one of a first lock state and a second lock state, and the second position being configurable to the define the other of the first lock state and the second lock state.

12. A lock actuation assembly according to claim 5, wherein movement of the turnable piece towards the first position has a configurable lock state to define one of a first and a second lock state, and wherein movement of the turnable piece towards the second position has a configurable lock state to define the other of the first lock state and the second lock state.

13. A lock actuation assembly according to claim 11, wherein the first lock state and second lock state are configurable via a remote interface.

14. A lock actuation assembly according to claim 11, wherein the lock state and second lock state are configured dependent on a sensed orientation of at least a part of the lock actuation assembly.

15. A lock actuation assembly according to claim 14, comprising an orientation sensor for sensing the orientation of the at least part of the lock actuation assembly.

16. A lock actuation assembly according to claim 1, wherein the controller determines and stores the state of the lock based on a comparison of: (i) a measured electrical characteristic associated with an actuation of the lock from a locked to an unlocked state; and (ii) a measured electrical characteristic associated with an actuation of the lock from an unlocked to a locked state.

17. A lock actuation assembly according to claim 1 wherein the lock actuation assembly further includes mechanical access to the coupler, from a side of the lock actuation assembly that faces away from the door, for physical manipulation of the coupler.

18. A lock actuation assembly according to claim 1 wherein turning the turnable piece causes electrically powered rotation of the coupler.

19. A lock actuation assembly according to claim 18 wherein said causation is by an electronic coupling, rather than a mechanical coupling, between the turnable piece and the coupler.

20. A lock actuation assembly according to claim 1 wherein the motor can be triggered in at least two ways to control the motor to generate the force, the two ways of triggering respectively being:
(i) by the lock actuation assembly wirelessly receiving a command; and
(ii) by turning the turnable piece with respect to a body of the lock actuation assembly.

21. A lock actuation assembly for actuating a change of a state of lock of a door via a lock actuator that extends from a panel of the door, the lock actuation assembly comprising:
a motor for driving the actuation of the change of the state of the lock by a mechanical force;
a body having a mounting portion for attaching the lock actuation assembly to the door;
a coupler held by the body for coupling the mechanical force to the lock actuator to change the state of the lock by turning the lock actuator relative to the body; and
a controller adapted to control the motor to generate the mechanical force to change the state of the lock based on a received command,
wherein the controller determines and stores the state of the lock based on a comparison of: (i) a measured electrical characteristic associated with an actuation of the lock from a locked to an unlocked state; and (ii) a measured electrical characteristic associated with an actuation of the lock from an unlocked to a locked state.

22. A lock actuation assembly according to claim 21 wherein the measured electrical characteristic associated with an actuation of the lock from a locked to an unlocked state, and the measured electrical characteristic associated with an actuation of the lock from an unlocked to a locked state, comprises a parameter indicative of power and/or energy consumption.

23. A lock actuation assembly according to claim 22, wherein the parameter is RMS current and/or peak current.

24. A lock actuation assembly according to claim 22, wherein the parameter required to drive the lock actuator is measured wherein a first measurement of the parameter is measured for a first actuation direction, and a second measurement of the parameter, is measured for a second, opposite, actuation direction, wherein the direction for which the parameter is greater is determined to be the direction to lock to the lock and the direction for which the parameter is lesser is determined to be the direction to unlock to the lock.

25. A lock actuation assembly according to claim 24, the determination of said state is made by the controller only in an event that the comparison of: (i) the measured electrical characteristic associated with an actuation of the lock from an unlocked to a locked state; and (ii) the measured electrical characteristic associated with an actuation of the lock from a locked to an unlocked state defines a metric that is greater than a predetermined threshold.

26. A lock actuation assembly according to claim 21 wherein the controller is configured to identify a defined direction of turning a turnable actuator as corresponding to either a locking or an unlocking action, based on said determined state of the lock.
